(19) United States
(12) Patent Application Publication
(10) Pub. No.: US 2010/0108771 A1
(43) Pub. Date: May 6, 2010

(54) FINANCIAL TRANSACTION CARD

(76) Inventors: Kwok Fong Wong, Hong Kong (HK); Pui Yi Ching, Hong Kong (HK)

Correspondence Address: BYIP, LTD., P.O. BOX 1484, GENERAL POST OFFICE, HONG KONG, HK

(21) Appl. No.: 12/486,766

(22) Filed: Jun. 18, 2009

(30) Foreign Application Priority Data
Oct. 30, 2008 (HK) 08111981.0
Dec. 9, 2008 (HK) 08113410.7

(51) Int. Cl. G06K 19/06

(52) U.S. Cl. 235/492

(57) ABSTRACT

A financial transaction card includes a housing, a flexible printed circuit board, an integrated circuit and an interface module. The housing includes a substrate and a cover. The flexible printed circuit board is disposed between the cover and the substrate. The integrated circuit is configured for driving the flexible printed circuit board to operate as a sensing device. The sensing device includes a fingerprint scanning module and a keyboard module. The interface module is electrically connected to the flexible printed circuit board and configured for electrically connecting the financial transaction card to an external device.

### CROSS-REFERENCE TO RELATED APPLICATIONS

This application claims the priority of Hong Kong short term patent application No. 08113410.7 filed on Dec. 9, 2008 and Hong Kong short term patent application No. 08111981.0 filed on Oct. 30, 2008.

### FIELD OF THE PATENT APPLICATION

The present patent application generally relates to financial transaction cards and more particularly to a financial transaction card that includes a flexible printed circuit board and incorporates the functions of fingerprint scanning and keyboard input.

### BACKGROUND

Financial transaction cards such as credit cards, debit cards, ATM (Automated Teller Machine) cards and so on have been widely used for some time, gaining popularity as convenient substitutes for cash. In the meantime, the demand for improved security and usability of the financial cards is increasing. In particular, it is desired to have a financial transaction card that can be used to scan a user's fingerprint and provide a keyboard for the user to securely and conveniently input confidential data therewith.

### SUMMARY

A financial transaction card is provided. In one aspect, the financial transaction card includes a housing having a substrate and a cover, a flexible printed circuit board disposed between the cover and the substrate, and an integrated circuit configured for driving the flexible printed circuit board to operate as a sensing device. The sensing device includes a fingerprint scanning module and a keyboard module. The cover of the housing includes a touch panel is above the flexible printed circuit board. The touch panel includes a pattern of a plurality of touch buttons printed on the cover.

The touch buttons may form a keyboard having number keys, letter keys and function keys.

The cover of the housing may include a window above the flexible printed circuit board, a portion of the flexible printed circuit board being exposed through the window.

The financial transaction may further include a storage module electrically connected to the flexible printed circuit board and configured for storing data.

The financial transaction card may further include an interface module electrically connected to the flexible printed circuit board and configured for electrically connecting the financial transaction card to an external device. The interface module includes a plurality of metal contacts, the metal contacts being disposed on a side of the financial transaction card.

The flexible printed circuit board may include a substrate and a plurality of connecting wires. Both the substrate and the connecting wires are transparent.

In another aspect, the financial transaction card includes a housing having substrate and a cover, a flexible printed circuit board disposed between the cover and the substrate, an integrated circuit configured for driving the flexible printed circuit board to operate as a sensing device, and an interface module electrically connected to the flexible printed circuit board and configured for electrically connecting the financial transaction card to an external device. The sensing device includes a fingerprint scanning module and a keyboard module.

The cover of the housing may include a touch panel above the flexible printed circuit board. The touch panel includes a pattern of a plurality of touch buttons printed on the cover. The touch buttons may form a keyboard having number keys, letter keys and function keys. The flexible printed circuit board may be configured to sense a user's touch on the keyboard and thereby to receive data input by the user.

The keyboard module may be configured to sense the user's touch by radio frequency electromagnetic waves.

The cover of the housing may include a window above the flexible printed circuit board. A portion of the flexible printed circuit board may be exposed through the window, and the flexible printed circuit board may be configured to scan a user's fingerprint through the window.

The fingerprint scanning module may be configured to scan the user's fingerprint by radio frequency electromagnetic waves.

The financial transaction may further include a storage module electrically connected to the flexible printed circuit board and configured for storing data.

The flexible printed circuit board may include a substrate and a plurality of connecting wires. Both the substrate and the connecting wires are transparent. The connecting wires may be made of indium tin oxide (ITO). The substrate of the flexible printed circuit board may be made of polyethylene terephthalate (PET).

The integrated circuit may be configured to control the fingerprint scanning module to acquire fingerprint scanning data, to control the keyboard module to acquire keyboard input data, and to transmit the fingerprint scanning data and the keyboard input data to an external device through the interface module.

The interface module may include a plurality of metal contacts, the metal contacts being disposed on a side of the financial transaction card.

The housing and the flexible printed circuit board are capable of being bent together as a whole piece.

### BRIEF DESCRIPTION OF THE DRAWINGS

FIG. 1 is an illustrative view of a financial transaction card according to an embodiment of the present application.

FIG. 2 is an illustrative view of a financial transaction card according to another embodiment of the present application.

FIG. 3 shows a front side and a back side of the financial transaction card illustrated in FIG. 2.

FIG. 4 is a circuit schematic diagram of the circuit on the flexible printed circuit board of the financial transaction card illustrated in FIG. 2.

FIG. 5 is a functional block diagram of the financial transaction card illustrated in FIG. 2.

### DETAILED DESCRIPTION

Reference will now be made in detail to embodiments of the financial transaction card in the present patent application, examples of which are also provided in the following description. Exemplary embodiments of the financial transaction card disclosed in the present patent application are described in detail, although it will be apparent to those skilled in the relevant art that some features that are not particularly important to an understanding of the financial transaction card may not be shown for the sake of clarity.

Furthermore, it should be understood that the financial transaction card disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

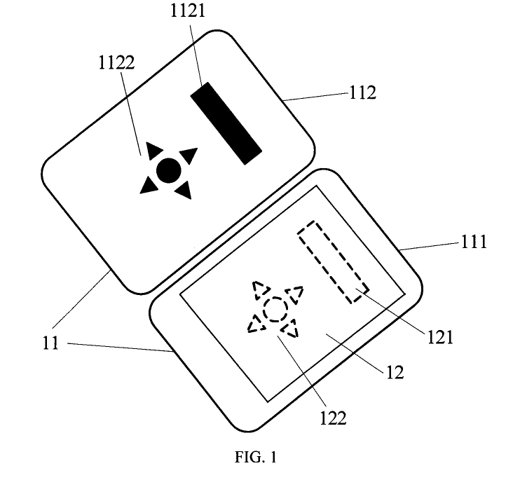

FIG. 1 is an illustrative view of a financial transaction card according to an embodiment of the present application. Referring to FIG. 1, the financial transaction card includes a housing 11 and a flexible printed circuit board 12. The housing 11 includes a substrate 111 and a cover 112, both of which are made of plastics. The flexible printed circuit board 12 is disposed between the substrate 111 and the cover 112. The housing 11 and the flexible printed circuit board 12 can be bent together as a whole piece.

The flexible printed circuit board 12 includes a substrate (not shown in FIG. 1) and a plurality of connecting wires (not shown in FIG. 1). The substrate of the flexible printed circuit board 12 is made of polyethylene terephthalate (PET). The connecting wires are made of indium tin oxide (ITO).

The financial transaction card in this embodiment further includes an integrated circuit (not shown in FIG. 1). The integrated circuit is configured for driving the flexible printed circuit board 12 so that the flexible printed circuit board 12 can operate as a sensing device. In this embodiment, the sensing device includes a keyboard module and a fingerprint scanning module. The keyboard module is configured to sense a touch by a user's finger so as to receive data input such as a password. The fingerprint scanning module is configured to scan a user's fingerprint so as to acquire the fingerprint information of the user. It is understood that the integrated circuit can be disposed on the flexible printed circuit board 12.

Referring to FIG. 1, a window 1121 is disposed on the cover 112 of the housing 11 above the flexible printed circuit board 12 and a portion of the flexible printed circuit board 12, namely a scanning area 121, is exposed through the window 1121. When a user places a finger on the window 1121, the scanning area 121, driven by the integrated circuit, is configured to operate as the fingerprint scanning module and scan the user's fingerprint. In this embodiment, the fingerprint scanning module is configured to scan the user's fingerprint by radio frequency (RF) electromagnetic waves.

Referring to FIG. 1, a touch panel 1122 is disposed on the cover 112 of the housing 11 above a sensing area 122 of the flexible printed circuit board 12. The touch panel 1122 includes a pattern of a plurality of touch buttons printed on the cover 112. The touch buttons form a keyboard that includes function keys such as directional keys, a confirmation key and etc. When a user's finger touches or presses the touch buttons, the sensing area 122 of the flexible printed circuit board 12, driven by the integrated circuit, operates as a keyboard module to receive commands associated with the touch buttons from the user.

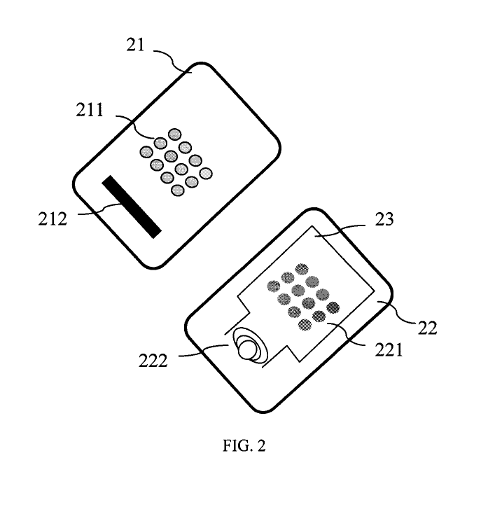

It is understood that the keyboard formed by the touch buttons may include other keys such as number keys and English letter keys. FIG. 2 is an illustrative view of a financial transaction card according to another embodiment of the present application. As shown in FIG. 2, a user can input a password that includes English letters and numbers and execute other operations such as language selection, deletion, confirmation and etc. through keyboard 211.

Referring to FIG. 2, the financial transaction card in this embodiment further includes a housing that has a cover 21 and a substrate 22. The keyboard 211 is formed by touch buttons printed on the cover 21 and disposed above a sensing area 221 of a flexible printed circuit board 23 between the cover 21 and the substrate 22. The sensing area 221 is configured for receiving data input by the user through the keyboard 211. A window 212 is disposed on the cover 21 and above a scanning area 222 of the flexible printed circuit board 23. When a user places a finger on the window 212, the scanning area 222 is configured to scan the fingerprint of the user. In this embodiment, the keyboard sensing can be realized by radio frequency (RF) electromagnetic waves.

The financial transaction card further includes a solid state storage device (not shown in FIG. 2) electrically connected to the flexible printed circuit board 23 and configured for storing data such as system files, user information and encrypted fingerprint data.

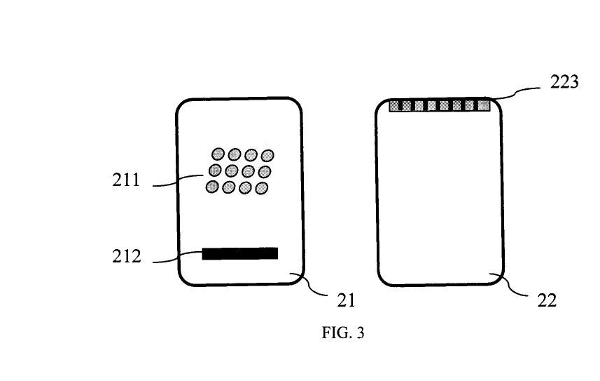

FIG. 3 shows a front side and a back side of the financial transaction card illustrated in FIG. 2. Referring to FIG. 3, the financial transaction card further includes an IC (integrated circuit) card interface. The IC card interface includes a plurality of metal contacts 223 for connecting the financial transaction card to external devices such as a card reader. The metal contacts 223 in this embodiment are electrically connected with the flexible printed circuit board 23.

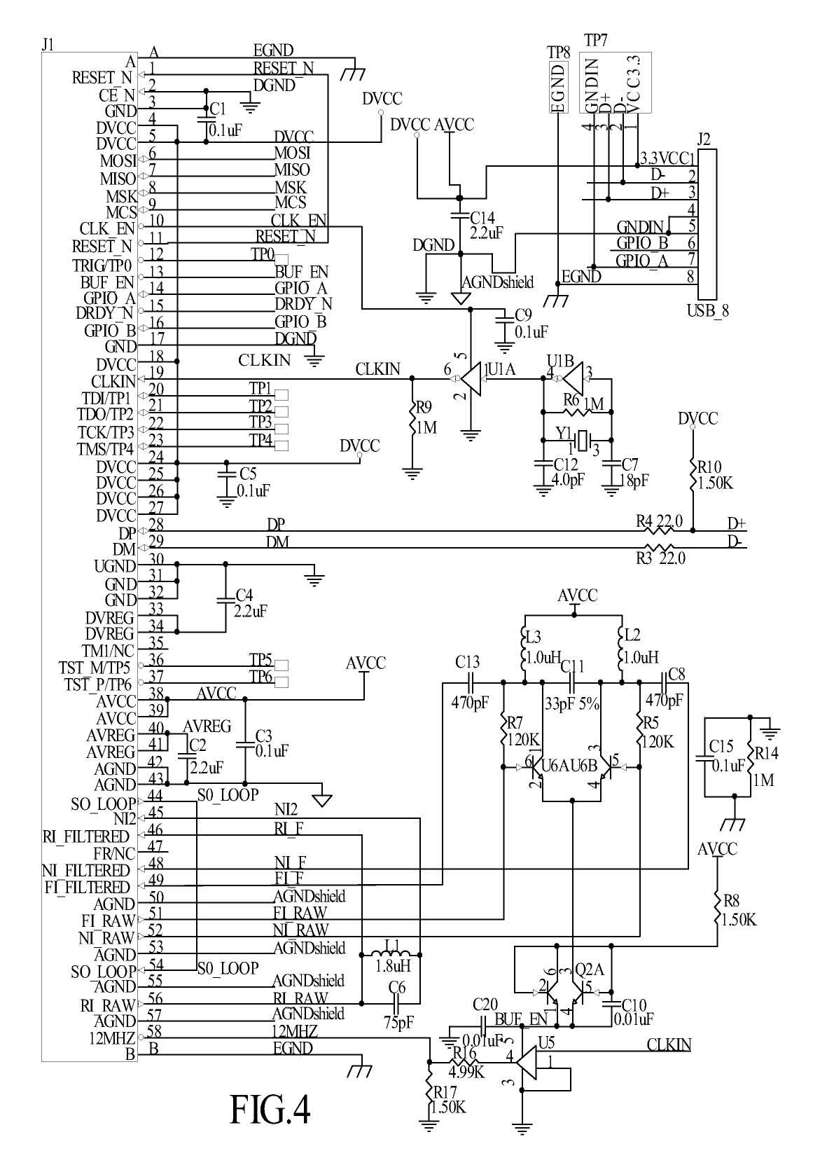

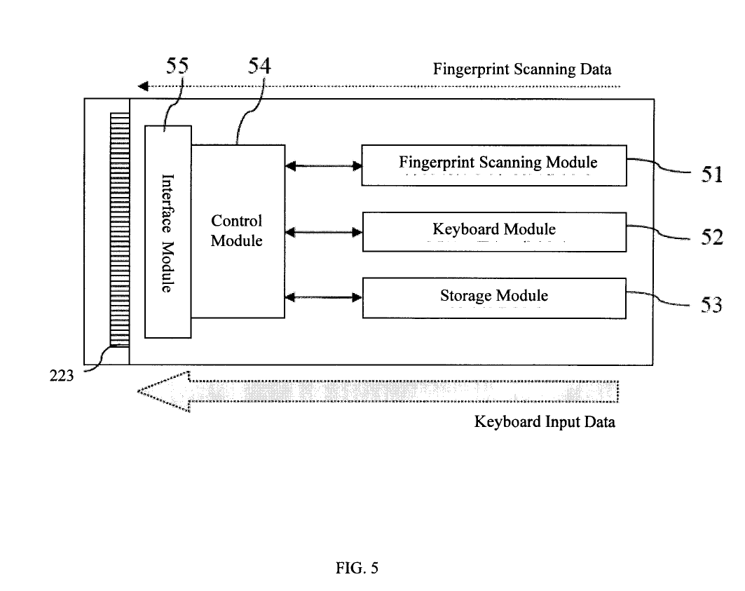

FIG. 4 is a circuit schematic diagram of the circuit on the flexible printed circuit board in this embodiment. FIG. 5 is a functional block diagram of the financial transaction card in this embodiment. Referring to FIG. 5, from a functional perspective, the financial transaction card includes a fingerprint scanning module 51, a keyboard module 52, a storage module 53, a control module 54 and an interface module 55. The fingerprint scanning module 51 is configured to scan a user's fingerprint through the window 212 (as shown in FIG. 2) by RF electromagnetic waves and corresponding to the scanning area 222 in FIG. 2. The keyboard module 52 is configured to receive data input by the user through the keyboard 211 (as shown in FIG. 2) and corresponding to the sensing area 221 in FIG. 2. As previously mentioned, the data may include a password composed by numbers, English letters and etc. The storage module 53 is configured to store data such as system files, user information and encrypted fingerprint data, and corresponding to the previously mentioned solid state storage device. The interface module 55 includes the metal contacts 223 (as shown in FIG. 2 and FIG. 5). The control module 54, corresponding to the previously mentioned integrated circuit, is configured to control the fingerprint scanning module 51 to acquire fingerprint scanning data, to control the keyboard module 52 to acquire keyboard input data, and to transmit the fingerprint scanning data and the keyboard input data to an external device through the interface module 55 so that the external device can compare the received data with the data stored in the storage module 53 and thereby verify the identity of the user.

In this embodiment, because the financial transaction card has a keyboard module 52 and a fingerprint scanning module 51, the need of providing an external keyboard or an external fingerprint scanning device at the location where the financial transaction card is used is eliminated. In addition, with the financial transaction card provided by this embodiment, the input of a user's password and the user's fingerprint can be combined to verify the user's identify, which makes the use of the financial transaction card more secure.

While the present patent application has been shown and described with particular references to a number of embodiments thereof, it should be noted that various other changes or modifications may be made without departing from the scope of the present invention.

What is claimed is:

1. A financial transaction card comprising:
a housing, the housing comprising a substrate and a cover;
a flexible printed circuit board disposed between the cover and the substrate;
an integrated circuit configured for driving the flexible printed circuit board to operate as a sensing device, the sensing device comprising a fingerprint scanning module and a keyboard module; and
an interface module electrically connected to the flexible printed circuit board and configured for electrically connecting the financial transaction card to an external device; wherein:
the cover of the housing comprises a touch panel above the flexible printed circuit board, the touch panel comprising a pattern of a plurality of touch buttons printed on the cover; and
the cover of the housing comprises a window above the flexible printed circuit board, a portion of the flexible printed circuit board being exposed through the window.

2. A financial transaction card comprising:
a housing, the housing comprising a substrate and a cover;
a flexible printed circuit board disposed between the cover and the substrate; and
an integrated circuit configured for driving the flexible printed circuit board to operate as a sensing device, the sensing device comprising a fingerprint scanning module and a keyboard module; wherein:
the cover of the housing comprises a touch panel is above the flexible printed circuit board, the touch panel comprising a pattern of a plurality of touch buttons printed on the cover.

3. The financial transaction card of claim 2, wherein the touch buttons form a keyboard comprising number keys, letter keys and function keys.

4. The financial transaction card of claim 2, wherein the cover of the housing comprising a window above the flexible printed circuit board, a portion of the flexible printed circuit board being exposed through the window.

5. The financial transaction card of claim 2, further comprising a storage module electrically connected to the flexible printed circuit board and configured for storing data.

6. The financial transaction card of claim 2, further comprising an interface module electrically connected to the flexible printed circuit board and configured for electrically connecting the financial transaction card to an external device, the interface module comprising a plurality of metal contacts, the metal contacts being disposed on a side of the financial transaction card.

7. The financial transaction card of claim 2, wherein the flexible printed circuit board comprises a substrate and a plurality of connecting wires, both the substrate and the connecting wires being transparent.

8. A financial transaction card comprising:
a housing, the housing comprising a substrate and a cover;
a flexible printed circuit board disposed between the cover and the substrate;
an integrated circuit configured for driving the flexible printed circuit board to operate as a sensing device, the sensing device comprising a fingerprint scanning module and a keyboard module; and
an interface module electrically connected to the flexible printed circuit board and configured for electrically connecting the financial transaction card to an external device.

9. The financial transaction card of claim 8, wherein the cover of the housing comprising a touch panel above the flexible printed circuit board, the touch panel comprising a pattern of a plurality of touch buttons printed on the cover.

10. The financial transaction card of claim 9, wherein the touch buttons form a keyboard comprising number keys, letter keys and function keys, and the flexible printed circuit board is configured to sense a user's touch on the keyboard and thereby to receive data input by the user.

11. The financial transaction card of claim 8, wherein the keyboard module is configured to sense the user's touch by radio frequency electromagnetic waves.

12. The financial transaction card of claim 8, wherein the cover of the housing comprising a window above the flexible printed circuit board, a portion of the flexible printed circuit board being exposed through the window, and the flexible printed circuit board is configured to scan a user's fingerprint through the window.

13. The financial transaction card of claim 8, wherein the fingerprint scanning module is configured to scan the user's fingerprint by radio frequency electromagnetic waves.

14. The financial transaction card of claim 8, further comprising a storage module electrically connected to the flexible printed circuit board and configured for storing data.

15. The financial transaction card of claim 8, wherein the flexible printed circuit board comprises a substrate and a plurality of connecting wires, both the substrate and the connecting wires being transparent.

16. The financial transaction card of claim 15, wherein the connecting wires are made of indium tin oxide (ITO).

17. The financial transaction card of claim 15, wherein the substrate of the flexible printed circuit board is made of polyethylene terephthalate (PET).

18. The financial transaction card of claim 8, wherein the integrated circuit is configured to control the fingerprint scanning module to acquire fingerprint scanning data, to control the keyboard module to acquire keyboard input data, and to transmit the fingerprint scanning data and the keyboard input data to an external device through the interface module.

19. The financial transaction card of claim 8, wherein the interface module comprises a plurality of metal contacts, the metal contacts being disposed on a side of the financial transaction card.

20. The financial transaction card of claim 8, wherein the housing and the flexible printed circuit board are capable of being bent together as a whole piece.
